(19) United States
(12) Patent Application Publication
(10) Pub. No.: US 2008/0282964 A1
(43) Pub. Date: Nov. 20, 2008

(54) Caution flag apparatus

(76) Inventor: Charles O. Bennett, Benton, LA (US)

Correspondence Address: John M. Harrison, 2139 E. Bert Kouns, Shreveport, LA, 71105, US

(21) Appl. No.: 12/152,243

(22) Filed: May 13, 2008

Related U.S. Application Data
(60) Provisional application No. 60/928,970, filed on May 14, 2007.

(51) Int. Cl. G09F 17/00; B60Q 1/50

(52) U.S. Cl. 116/28 R; 116/173

(57) ABSTRACT

A caution flag apparatus for mounting on a vehicle which includes in one embodiment, a pipe bracket hinged to the side of the vehicle and pivotally attached to a flag storage pipe or tube which receives a flag and flag rod. A flag rod bracket carries the flag rod at one end and the opposite end of the flag rod bracket is attached to a hinged bracket carrying a conventional stop sign. A conventional drive motor is mounted on the side of the vehicle and causes the hinged bracket, stop sign, flag rod bracket, flag rod, pipe bracket and flag storage pipe to selectively pivot inwardly and outwardly of the vehicle in an arc. Extension of the flag storage pipe outwardly of the vehicle effects extension of the flag and the free end of the flag rod from the flag storage pipe into a deployed configuration in or near the lane of an oncoming or passing automobile. In a second embodiment, a second drive motor is provided in spaced-apart relationship on the side of the vehicle with respect to the first drive motor and pivotally mounts a pivot arm which is attached to a flag storage pipe or tube containing a flag located at one end of a flag rod. The opposite end of the flag rod is hingedly connected to the vehicle, such that operation of the second drive motor pivots the pivot arm, flag storage pipe and the flag rod selectively inwardly and outwardly of the vehicle in an arc independently of the stop sign and causes projection of the flag on the end of the flag rod from the flag storage pipe, such that the flag is deployed in the lane of an oncoming or passing automobile.

### CROSS-REFERENCE TO RELATED APPLICATIONS

This application claims the benefit of and incorporates by reference prior filed copending U.S. Provisional Application Ser. No. 60/928,970, filed May 14, 2007.

### BACKGROUND OF THE INVENTION

### Field of the Invention

This invention relates to safety devices for school buses, public works vehicles and other vehicles which must make periodic stops in traffic to load and unload passengers or workers. More particularly, the invention relates to bracket and pivot arm-activated safety flags, each pivotally mounted on a typically flexible rod on a vehicle such as a school bus and designed to project-from the bus when deployed in functional configuration to serve as a warning to motorists behind and in front of the bus. In a first embodiment, the free end of the flag rod and the safety flag are caused to selectively extend from and retract into a flag storage pipe or tube attached to a pipe bracket which is pivoted to the school bus. The opposite end of the flag rod is attached to a flag rod bracket secured to a conventional stop sign drive motor, which operates to extend and retract a stop sign as well as the flag rod bracket, pipe bracket, flag storage tube and flag rod carrying the flag, in an arc with respect to the bus.

In a second embodiment, a second drive motor is provided in spaced-apart relationship with respect to the stop sign drive motor at the front of the bus and is also mounted on the bus. When activated, the second drive motor causes a pivot arm carried by the drive motor and attached to the flag storage pipe or tube, to selectively pivot inwardly and outwardly of the bus in an arc, along with a pivotally-mounted flag rod that projects into the flag storage pipe with a caution flag. This outwardly pivoting pivot arm action extends the flag from the flag storage pipe and deploys the flag in the lane of an oncoming automobile or a passing vehicle. In both embodiments the flag is caused to project from the respective flag storage pipes because the flag rod is longer than either the pipe bracket or pivot arm.

The safety flag devices of this invention are designed to slow or stop the flow of traffic around a school bus, public works truck or other vehicle which is required to make periodic stops in traffic, in order to enhance the safety of the occupants of the vehicle as they enter and leave the vehicle. When pivotally extended from a vehicle in an arc, the safety flag also projects on a flexible rod linearly from a flag storage pipe or tube and warns motorists behind and in front of the bus or vehicle of the danger to persons entering or departing when the vehicle is stopped. The devices both operate simultaneously with the pivoting of a conventional stop sign or signs from folded transportation mode against the vehicle, to pivotal extended configurations outwardly of the vehicle.

A major cause of accidents involving school children who ride to and from school in city, parish or county-operated school buses is the injury or death of children by motorists who attempt to pass the bus after the latter has come to a stop and the passengers are loading or unloading. In spite of the conventional manual and automatic arm mechanism or mechanisms which open when the bus is stopped to display the familiar octagon-shaped stop sign or signs at the front and sometimes at the rear of the bus, impatient motorists sometimes persist in passing the bus from both directions, running the risk of striking a child or other passenger walking into the path of the moving vehicle, typically from the front of the bus. The safety flag devices of this invention are designed to at least minimize this hazard by extending a caution or warning flag into the lane of traffic adjacent to the bus or other vehicle to act as an additional warning to motorists following or facing the bus.

### SUMMARY OF THE INVENTION

A caution flag apparatus for mounting on a vehicle which includes in one embodiment, a pipe bracket hinged to the side of the vehicle and pivotally fitted with a flag storage pipe or tube for slidably receiving a flag attached to one end of a flag rod. The opposite end of the flag rod is attached to a flag rod bracket connected to a hinged pivoting bracket carrying a conventional stop sign and attached to the vehicle. A conventional drive motor operates the stop sign and also causes the hinged bracket, flag rod bracket, flag rod, pipe bracket and flag storage pipe to selectively pivot inwardly and outwardly of the vehicle. Extension of the flag rod bracket, flag rod, pipe bracket and flag storage pipe in an arc outwardly of the bus effects projection of the free flag rod end and attached flag from the flag storage pipe into a deployed configuration in the adjacent lane of an oncoming or passing automobile. In a second embodiment, a second drive motor is provided in spaced-apart relationship on the side of the vehicle with respect to the first, front-mounted drive motor and pivotally mounts a pivot arm which is pivotally attached to a flag storage pipe containing a flag rod and a flag located at one end of the flag rod. The opposite end of the flag rod is hinged to the vehicle, such that operation of the second drive motor pivots the pivot arm, flag storage pipe and flag rod outwardly of the vehicle in an arc and causes linear extension of the flag on the end of the flag rod from the flag pipe, such that the flag is deployed in the lane of traffic of an oncoming or passing automobile.

### BRIEF DESCRIPTION OF THE DRAWINGS

The invention will be better understood by reference to the accompanying drawings, wherein:

FIG. 1 is a perspective view of a bracket caution flag apparatus embodiment of this invention, which apparatus is illustrated in folded, non-functional, transportation configuration against the side of a school bus;

FIG. 2 is an enlarged view of a preferred storage pipe retainer device for mounting on the bus and receiving and removably securing the flag storage pipe element of the bracket caution flag apparatus in the transportation configuration illustrated in FIG. 1;

FIG. 3 is a perspective view of the bracket caution flag apparatus illustrated in FIG. 1 in partially deployed configuration, more particularly illustrating extension of a safety flag and flag rod from the end of the flag storage pipe as the flag storage pipe, pipe bracket, flag rod and flag rod bracket pivot outwardly of the school bus responsive to operation of a conventional stop sign drive motor;

FIG. 4 is an enlarged view of a typical conventional stop sign hinge arrangement for mounting the flag rod bracket element of the bracket caution flag apparatus and operating the flag rod bracket by the conventional stop sign drive motor;

FIG. 5 is a perspective view of the bracket caution flag apparatus illustrated in FIGS. 1-4, more particularly illustrating the safety flag, flag storage pipe, pipe bracket and flag rod bracket in fully deployed configuration, along with the conventional stop sign;

FIG. 6 is a perspective view of a pivot arm caution flag apparatus embodiment of the invention, more particularly illustrating a second drive motor which pivotally carries a pivot arm also pivoted to a flag storage pipe and wherein the flag storage pipe slidably receives a flag and a flag rod connected to a flag mount bracket pivotally attached to the side of the bus;

FIG. 7 is a top perspective view of the pivot arm caution flag apparatus illustrated in FIG. 6, more particularly illustrating the safety flag, flag rod, flag storage pipe and pivot arm elements in fully deployed configuration; and

FIG. 8 is a bottom perspective view of the pivot arm caution flag apparatus illustrated in FIGS. 6 and 7.

### DESCRIPTION OF THE PREFERRED EMBODIMENTS

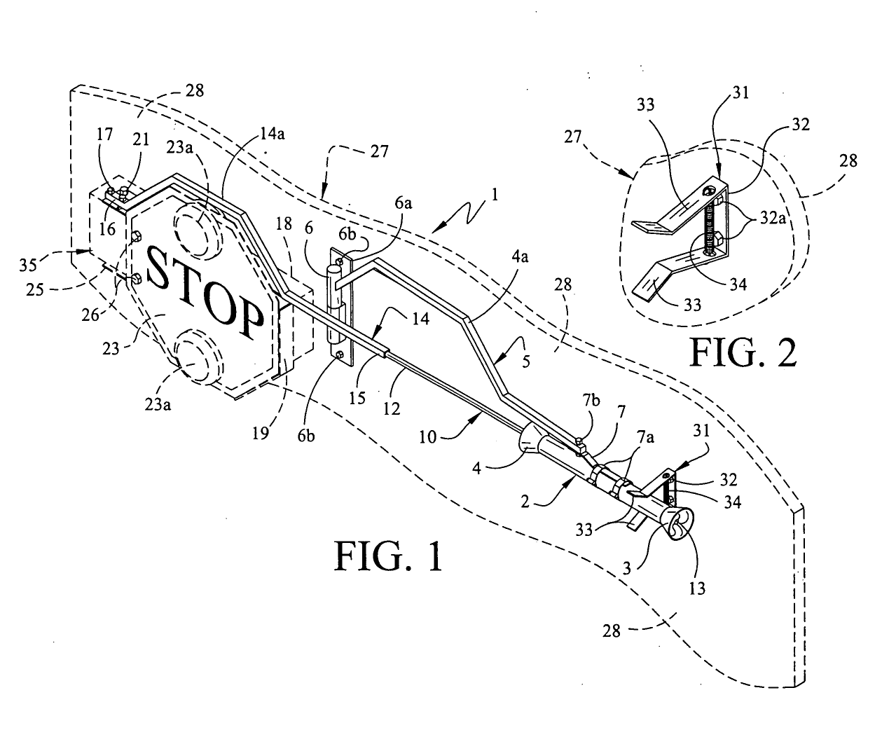

Referring initially to FIGS. 1-5 of the drawings, in a first embodiment a bracket caution flag apparatus is generally illustrated by reference numeral 1 and includes a flag storage tube or pipe 2, which is typically characterized by a flared flag end 3 and flared rod end 4. The flag storage pipe 2 is pivotally connected to one end of a pipe bracket 5, typically by means of a pipe mount plate 7, using a pair of clamps 7a and a hinge bolt 7b, fitted with a nut 7c. Accordingly, the flag storage pipe 2 is permitted to pivot with respect to the pipe bracket 5, as hereinafter further described. The opposite end of the pipe bracket 5 from the flag storage pipe 2 is connected to the bus side panel 28 of a bus 27 (illustrated in phantom), typically a school bus, using a bracket hinge 6, typically fitted to a hinge plate 6a that is attached to the bus side panel 28 by a pair of hinge plate mount bolts 6b. Accordingly, the pipe bracket 5 is permitted to swing from and to the bus side panel 28 of the bus 27 by operation of the bracket hinge 6. An arch 4a is provided in the pipe bracket 5 for purposes which will be hereinafter further described.

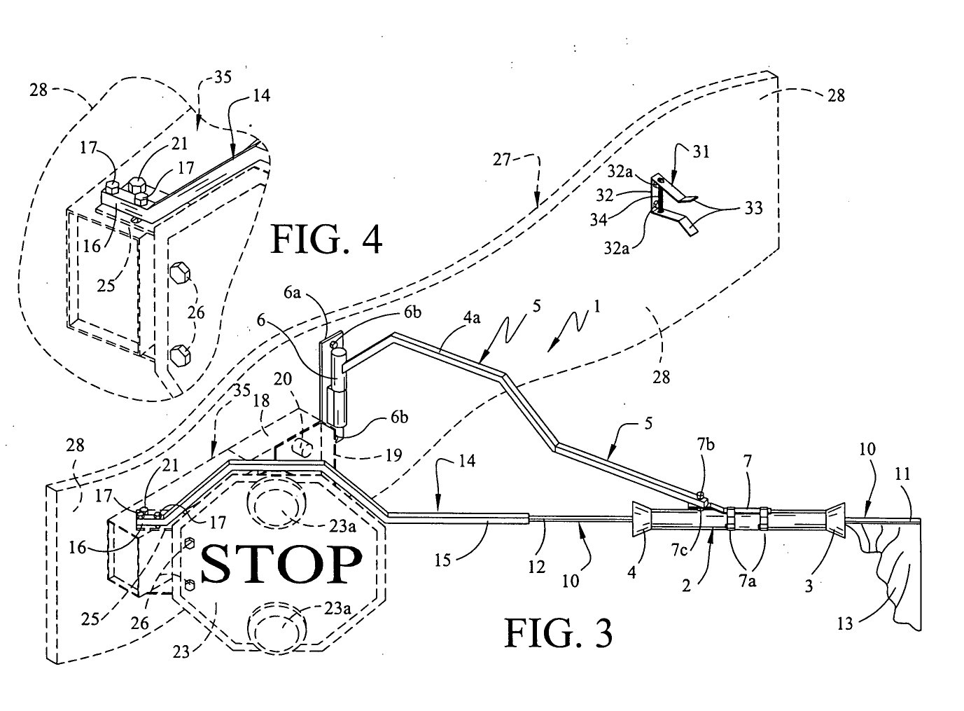

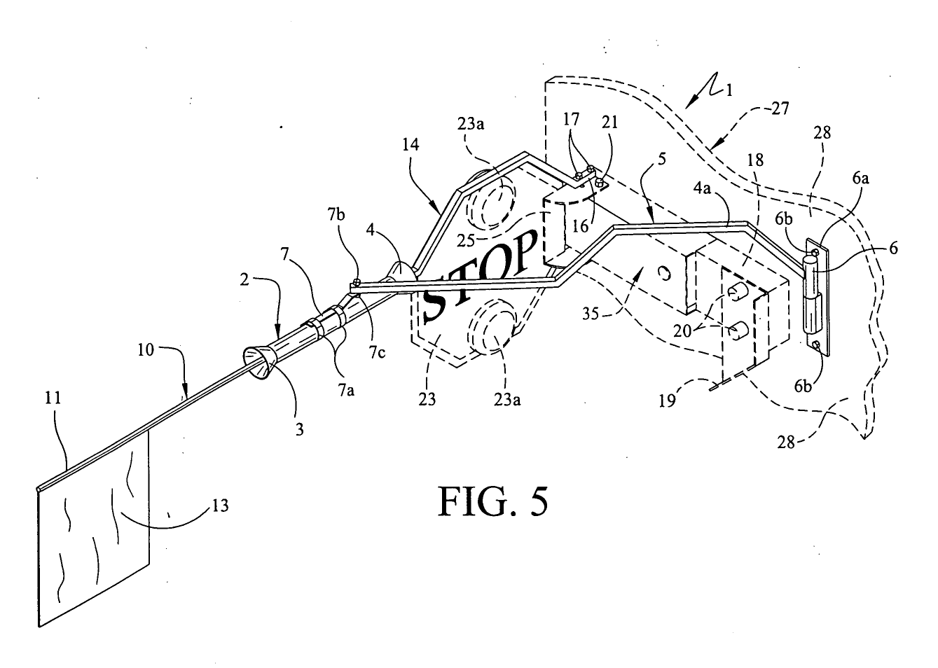

The bracket mount end 16 of a flag rod bracket 14 is fitted to a stop sign mount bracket 25, typically by bracket mount bolts 17. The stop sign mount bracket 25 is conventionally provided on the bus side panel 28 for pivotally mounting a conventional stop sign 23, typically fitted with reflectors 23a and secured by stop sign mount bolts 26, all illustrated in phantom. The stop sign 23 is permitted to pivot conventionally inwardly against a pair of stop sign rests 20, adjacent a conventional stop sign plate 19, located on a conventional spacer 18 (both illustrated in phantom) fitted against the bus side panel 28 (FIG. 1). The stop sign 23 also extends from the bus side panel 28 into functional configuration (FIG. 5) and both of the opening and closing functions are orchestrated by operation of the stop sign motor 35, conventionally mounted on the front area of the bus side panel 28 of the bus 27. A flexible flag rod 10 has a base end 12 attached to the rod mount end 15 of the flag rod bracket 14 and the free end of the flag rod 10 extends and slides into a flag storage pipe 2, with a flag 13 attached to the free flag end 11 of the flag rod 10 (FIGS. 3 and 5). As further illustrated in FIGS. 1 and 2, a storage pipe clip or retainer 31 is typically attached to the bus side panel 28 using base mount bolts 32a at a retainer base 32 and a pair of shaped retainer legs 33 extend from the retainer base 33 in spaced-apart relationship with respect to each other to receive and secure the flag storage pipe 2 when the flag storage pipe 2 is in the secured, travel configuration illustrated in FIG. 1. A retainer spring 34 may be provided between the retainer legs 33 to bias the retainer legs 33 against the flag storage pipe 2, as further illustrated in FIGS. 1 and 2.

Referring again to FIGS. 1-5 of the drawings, under-circumstances where it is desired to pivot the bracket caution flag apparatus 1 into the intermediate and functional configurations illustrated in FIGS. 3 and 5, respectively, from the travel configuration illustrated in FIG. 1, the direct current stop sign motor 35 is initially activated by the bus driver. This action causes the stop sign mount bracket 25 to pivot with the bracket mount bolt 17 and swing the stop sign 23 outwardly of the bus side panel 28 (FIG. 3). This causes the flag rod bracket 14 to also pivot outwardly of the bus side panel 28 on the stop sign mount bracket 25 along with the stop sign 23, as further illustrated in FIG. 3, causing the pipe bracket 5 to pivot on the bracket hinge 6, along with the flag storage pipe 2. Continued outward pivoting of the flag rod bracket 14 away from the bus side panel 28 in an arc also causes the flag rod 10 to slide inside the flag storage pipe 2 and extend the flag 13, along with the flag end 11 of the flag rod 10 from the flag storage pipe 2, as illustrated in FIG. 3. This extension or projection of the flag 13 outwardly of the flag storage pipe 2 is caused by the closing proximity of the flag storage pipe 2 to the bracket hinge 6 and the length of the flag rod 10, as the flag storage pipe 2 swings in an arc through the position illustrated in FIG. 3 to the functional deployment shown in FIG. 5. Accordingly, full deployment of the flag rod bracket 14 in a position substantially perpendicular with respect to the bus side panel 28 by operation of the stop sign motor 35, positions the flag storage pipe 2 and the pipe bracket 5 in the configuration illustrated in FIG. 5, with the flag 13 fully extended on the flag rod 10 from the flag storage pipe 2. Retraction of the bracket caution flag apparatus 1 to the configuration illustrated in FIG. 1 from the configuration illustrated in FIG. 5 is effected by reversing operation of the stop sign motor 35 and causing the apparatus to pivot rearwardly through the position illustrated in FIG. 3, back to the travel configuration illustrated in FIG. 1. The arch 4a is provided in the pipe bracket 5 to facilitate a clear view of the stop sign 23 by motorists when the bracket caution flag apparatus 1 is in the functional configuration illustrated in FIG. 5.

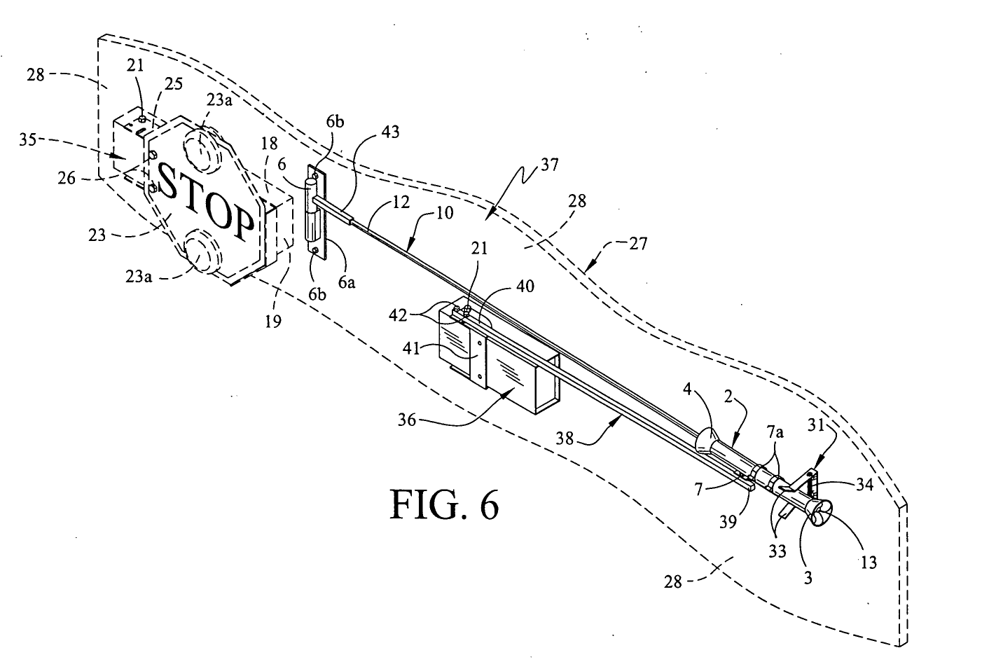

In another embodiment of the invention, a pivot arm caution flag apparatus 37 is illustrated in FIGS. 6-8 of the drawings and includes a pivot arm motor 36, mounted on the bus side panel 28 of the bus 27 in spaced-apart relationship with respect to the front stop sign motor 35, heretofore described. When in folded configuration, the pivot arm caution flag apparatus 37 is detailed as illustrated in FIG. 6, such that the flag storage pipe 2 engages the extending and spaced-apart retainer legs 33 of the storage pipe retainer 31, described above. The typically flexible flag rod 10 is mounted on a flag rod mount bracket 43, which is attached to a bracket hinge 6, typically secured to the bus side panel 28 using a hinge plate 6a and corresponding hinge plate mount bolts 6b. As in the case of the bracket caution flag apparatus 1 heretofore described, the flag rod 10 lies alongside the bus side panel 28 and extends into the flag storage pipe 2 while the device is in the folded travel configuration illustrated in FIG. 6. A pivot arm 38 has a distal end 39 pivotally secured to the flag storage pipe 2, typically by means of clamps 7a, extending around a pipe mount plate 7. The opposite or proximal end 40 of the pivot arm 38 is secured to a pivot arm bracket 41, typically by a pair of pivot arm bracket bolts 42. The pivot arm bracket 41 is in turn pivotally attached to the pivot arm motor 36 at a bracket arm bolt 21, as further illustrated in FIGS. 6-8.

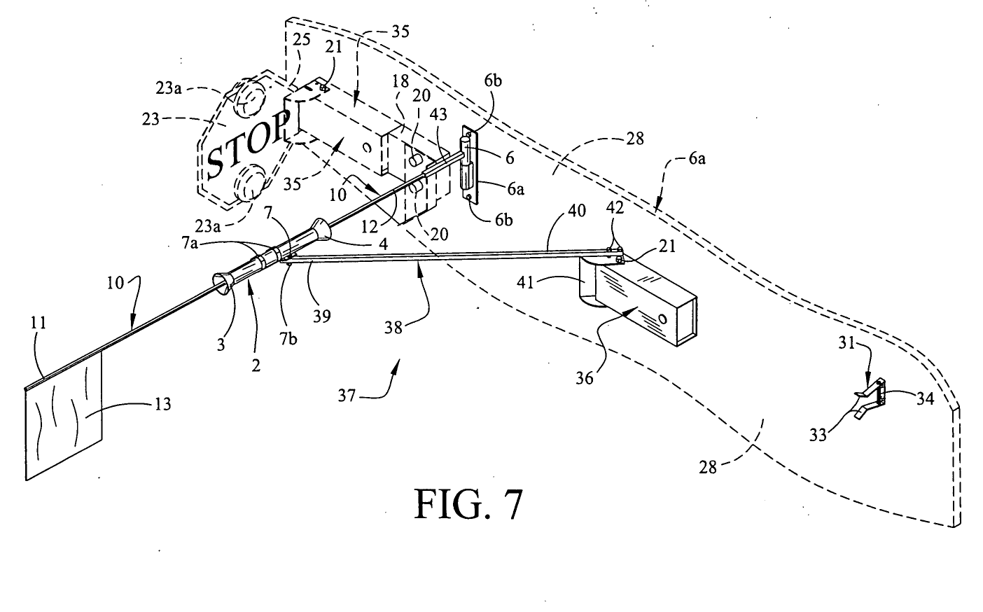

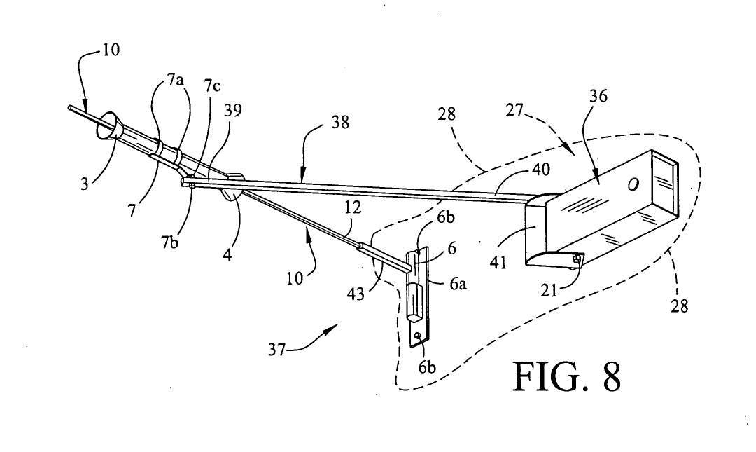

Referring now to FIGS. 7 and 8 of the drawings, under circumstances where the pivot arm 38 of the pivot arm caution flag apparatus 37 is extended by operation of the pivot arm motor 36, the pivot arm 38 is caused to swing outwardly of the bus side panel 28 by the pivoting action of the pivot arm bracket 41, which is driven by the pivot arm motor 36. The flag rod 10 and attached flag rod mount bracket 43, secured to the bracket hinge 6, also swing outwardly by operation of the pivot arm 38 and the flag end 11 of the flag rod 10 extends from the flag end 3 of the flag storage pipe 2, along with the flag 13, which is attached to the flag end 11 of the flag rod 10. The pivoting function of the flag storage pipe 2 on the distal end 39 of the pivot arm 38 is typically effected by operation of a hinge bolt 7b, which extends through the distal end 39 of the pivot arm 38 and is typically secured in place by a nut 7c, as illustrated in FIG. 8 of the drawings. As further illustrated in FIGS. 7 and 8 of the drawings, the stop sign 23 is also pivoted outwardly into functional configuration by operation of the stop sign motor 35, which operates simultaneous with, but independently of, operation of the pivot arm motor 36. Accordingly, the pivot arm caution flag apparatus 37 swings outwardly of the bus side panel 28 from the FIG. 6 position in an arc, to the position illustrated in FIGS. 7 and 8, where it is fully deployed, with the flag 13 extending from the flag storage pipe 2 on the flag rod 10. Reversal of the pivot arm motor 36 effects swinging of the pivot arm caution flag apparatus back into the position illustrated in FIG. 1, with the flag 13 again recessed inside the flag storage pipe 2. Extension and retraction of the flag 13 is effected due to the relative proximity of the flag 13 with respect to the bracket hinge 6, as heretofore described.

Referring again to the drawings, it will be appreciated that in both embodiments of this invention the flared rod end 4 of the flag storage tube or pipe 2 need not be flared, but can be the same diameter as the flag storage pipe 2 if so desired. The same is true for the flag end 3, although the flag end 3 is more preferably flared in order to accommodate the flag 13 when the flag storage pipe 2 is swung back into the travel configuration from the deployed configuration and the flag 13 is again relocated inside the flag storage pipe 2. The flag 13 may be manufactured of any desired material but in a preferred embodiment is a soft like material such as silk, to facilitate easier random folding or compression of the flag 13 during entry of the flag 13 into the flag storage pipe 2. This quality reduces friction and resistance of the flag 13 during such entry.

While the preferred embodiments of the invention have been described above, it will be recognized and understood that various modifications may be made therein and the appended claims are intended to cover all such modifications which may fall within the spirit and scope of the invention.

Having described my invention with the particularity set forth above, what is claimed is:

1. a caution flag apparatus for a vehicle comprising a drive motor carried by the vehicle; a pivot arm having one pivot arm end attached to said drive motor in driving relationship and the opposite pivot arm end of said pivot arm extending from said drive motor; a flag storage pipe pivotally carried by said opposite pivot arm end of said pivot arm; a flag rod having one flag arm end pivotally attached to the vehicle and the opposite flag arm end of said flag arm projecting at least into said flag storage pipe; and a flag attached to said opposite flag arm end of said flag arm, wherein said opposite flag arm end of said flag arm and said flag are slidably enclosed in said flag storage pipe when said flag storage pipe is disposed in travel configuration against the vehicle and said opposite flag arm end of said flag arm and said flag are slidably projected from said flag storage pipe when said pivot arm, said flag storage pipe and said flag arm are pivoted outwardly of the vehicle responsive to operation of said drive motor.

2. The caution flag apparatus of claim I comprising a storage pipe retainer provided on the vehicle for removably receiving said flag storage pipe when said flag storage tube is disposed in said travel configuration against the vehicle.

3. The caution flag apparatus of claim 1 comprising a mount plate pivotally connected to said opposite pivot arm end of said pivot arm and at least one clamp engaging said mount plate and said flag storage pipe for removably securing said mount plate on said flag storage pipe.

4. The caution flag apparatus of claim 3 comprising a storage pipe retainer provided on the vehicle for removably receiving said flag storage pipe when said flag storage pipe is disposed in said travel configuration against the vehicle.

5. The caution flag apparatus of claim 1 where said flag storage pipe is flared for receiving said flag when said flag storage pipe is disposed in said travel configuration.

6. The caution flag apparatus of claim 5 comprising:
(a) a storage pipe retainer provided on the vehicle for removably receiving said flag storage pipe when said flag storage pipe is disposed in said travel configuration against the vehicle; and
(b) a mount plate pivotally connected to said opposite pivot arm end of said pivot arm and at least one clamp engaging said mount plate and said flag storage pipe for removably securing said mount plate on said flag storage pipe.

7. A caution flag apparatus for a vehicle comprising a drive motor mounted on the vehicle; a pivot arm having one pivot arm end attached to said drive motor in pivotally driving relationship and the opposite pivot arm end of said pivot arm extending from said drive motor; a flag storage pipe or tube pivotally attached to said opposite pivot arm end of said pivot arm; a flag rod having one flag arm end pivotally attached to the vehicle and the opposite flag arm end of said flag arm slidably projecting into said flag storage tube; and a caution flag attached to said opposite flag arm end of said flag arm, wherein said opposite flag arm end of said flag arm and said flag are slidably disposed in said flag storage tube when said flag storage tube is positioned in travel configuration against the vehicle and said opposite flag arm end of said flag arm and said flag are slidably extended from said flag storage tube when said pivot arm said flag arm tube and said flag arm are pivoted outwardly of the vehicle responsive to operation of said drive motor.

8. The caution flag apparatus of claim 7 comprising a storage tube retainer provided on the vehicle for removably receiving and securing said flag storage tube when said flag storage tube is disposed in said travel configuration against the vehicle.

9. The caution flag apparatus of claim 8 comprising a mount plate pivotally connected to said opposite pivot arm end of said pivot arm and at least one fastener engaging said flag storage tube for removably securing said mount plate on said flag storage tube.

10. The caution flag apparatus of claim 9 wherein said flared storage tube is flared for receiving said flag when said flag storage tube is disposed in said travel configuration.

11. The caution flag apparatus of claim 7 wherein said flag rod is longer than said pivot arm.

12. The caution flag apparatus of claim 11 comprising:
(a) a storage tube retainer provided on the vehicle for removably receiving and securing said flag storage tube when said flag storage tube is disposed in said travel configuration against the vehicle; and
(b) a mount plate pivotally connected to said opposite pivot arm end of said pivot arm and at least one fastener engaging said flag storage pipe for removably securing said mount plate on said flag storage pipe.

13. A caution flag apparatus for a vehicle provided with a warning sign opening and closing mechanism having a hinge carrying a warning sign and capable of opening into an open configuration and closing into a closed configuration by operation of the hinge, said caution flag apparatus comprising a flag rod having one flag rod end carried by the hinge and the opposite flag rod end of said flag rod extending from the hinge; a warning flag provided on said flag rod end of said flag rod; a flag storage pipe slidably deployed on said flag rod; a pipe bracket having one bracket end pivotally attached to the vehicle and the opposite bracket end of said pipe bracket projecting for pivotal attachment to said flag storage pipe, wherein said flag is deployed within said flag storage pipe when said flag storage pipe is in said closed configuration of said warning sign and said flag is deployed outside of said flag storage pipe when the warning sign is in said open configuration, responsive to operation of the opening and closing mechanism and sliding of said flag rod and said flag in said flag storage pipe.

14. The caution flag apparatus of claim 13 comprising a storage pipe retainer provided on the vehicle for removably receiving said flag storage pipe when said flag storage pipe is disposed in said travel configuration against the vehicle.

15. The caution flag apparatus of claim 13 comprising a mount plate pivotally connected to said opposite pivot arm end of said pivot arm and at least one clamp engaging said mount plate and said flag storage pipe for removably securing said mount plate on said flag storage pipe.

16. The caution flag apparatus of claim 13 wherein said flag storage pipe is flared for receiving said flag when said flag storage pipe is disposed in said travel configuration and comprising a mount plate pivotally connected to said opposite pivot arm end of said pivot arm and at least one clamp engaging said mount plate and said flag storage pipe for removably securing said mount plate on said flag storage pipe.

17. The caution flag apparatus of claim 13 wherein said flag rod is longer than said pivot arm.

18. The caution flag apparatus of claim 17 comprising:
(a) a storage pipe retainer provided on the vehicle for removably receiving and securing said flag storage pipe when said flag storage pipe is disposed in said travel configuration against the vehicle; and
(b) a mount plate pivotally connected to said opposite pivot arm end of said pivot arm and at least one fastener engaging said flag storage pipe for removably securing said mount plate on said flag storage pipe.

19. The caution flag apparatus of claim 18 wherein said storage pipe is flared for receiving said flag when said flag storage pipe is disposed in said travel configuration.

20. The caution flag apparatus of claim 19 wherein said flag rod is shaped from a substantially resilient material and said flag is silk.
